(19) United States
(12) Patent Application Publication
(10) Pub. No.: US 2007/0272347 A1
(43) Pub. Date: Nov. 29, 2007

(54) Method and apparatus for forming a coating on an element

(76) Inventors: Donald T. Coleman, Plainfield, IL (US); Robert A. Pelisek, Marengo, IL (US)

Correspondence Address: JONES DAY, 77 WEST WACKER, CHICAGO, IL, 60601-1692, US

(21) Appl. No.: 11/440,518

(22) Filed: May 25, 2006

(51) Int. Cl. B44C 1/165; B65H 37/00; B32B 37/00

(52) U.S. Cl. 156/230; 156/234; 156/540; 156/542; 156/500

(57) ABSTRACT

An apparatus and method for coating the peripheral surfaces of a large plastic television frame. The frame is mounted on a special metal fixture having a surface that complements the peripheral surfaces of the frame. Composite material on a foil having good abrasion resistance, good chemical resistance, selective adhesion properties and high gloss characteristics is bonded to the plastic frame using heat and pressure, but bonding does not occur between the metal fixture and the composite material even though the same heat and pressure are applied to the composite material and to the fixture. The bonding apparatus includes a conveyor system, a foil dispensing roll, a foil take-up roll, a heated roller and structure to move the heated roller so as to squeeze the foil between the roller and the moving fixture and frame assembly. A complete manufacturing system includes a frame molding machine, the bonding apparatus, an inspection station and a packaging station.

### CROSS REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The present invention relates to a method and apparatus for forming a coating or an element and, more particularly, to a method and apparatus for forming a coating using a foil on a large plastic element having an interrupted a discontinuous surface. The foil includes a carrier layer and composite material to form a decorative coating on the large plastic element.

2. Description of the Related Art

The application of a composition layer or a coating on a small continuous or uninterrupted surface is known. For example, U.S. Pat. No. 5,013,386 discloses a device for a applying a thin roll of material to a surface. The device will flat stamp roll leaf onto a variety of substrates for the purpose of creating original works of art.

Another example is found in U.S. Pat. No. 6,361,839 which discloses a method of hot stamping foil having a layer including thermochromic and antimicrobial compounds. In one embodiment the foil includes a carrier which has disposed on its surface a thermochromic layer comprising a mixture of a thermochromic compound, an adhesive compound, a release compound and an antimicrobial compound. The foil is hot stamped on an article of manufacture causing the thermochromic layer to adhere to the article. Thereafter the carrier foil is removed. The patent states that the process may be applied to plastic, wood, paper, and leather.

Yet another example is found in U.S. Pat. No. 6,726,982. Disclosed there are thermal transfer imaging compositions and graphic articles, often used in retroreflective sheeting from which are manufactured items such as license plates, road and street markings, validation stickers, package labels, and decals, like those used for automotive brands and decoration.

These articles and items tend to be relatively small and have continuous surfaces. Larger items with discontinuous, spaced apart or interrupted surfaces present much more difficulty.

### BRIEF SUMMARY OF THE INVENTION

The limitations encountered with previous processes have been overcome by the present invention. What is described here is a method for forming a decorative coating to a one-piece, relatively large element having a large discontinuous or interrupted surface including engaging the element with a fixture having a complementing surface and applying composite material which adheres to the surface of the element but not to the surface of the fixture. An apparatus for accomplishing the method is also disclosed, as is the foil to be used.

A complete understanding of the present invention and advantages, features and objects thereof will be gained from a consideration of the present specification which provides a written description of the invention and of the manner and process of making and using the invention set forth in such full, clear, concise and exact terms as to enable any person skilled in the art to which it pertains, or with which it is most nearly connected, to make and use the same in compliance with Title 35, U.S.C. §112 (first paragraph). Furthermore, the following description of a preferred embodiment of the invention read in conjunction with the accompanying drawing provided herein represents an example of the invention in compliance with Title 35, U.S.C. §112 (first paragraph), but the invention itself is defined in the Claims section attached hereto.

### BRIEF DESCRIPTION OF THE SEVERAL VIEWS OF THE DRAWING

FIG. 1 is an isometric view of a sample television set on a table, the television set having a large, plastic frame mounted around a flat viewing screen.

FIG. 2 is an isometric view of the plastic frame.

FIG. 3 is an enlarged front elevation view of the television set with a plastic frame decorated with a logo of a sports team.

FIG. 4 is an exploded isometric view of another sample television set and a snap-on plastic frame.

FIG. 5 is an exploded isometric view of a plastic frame to be coated mounted to a special fixture.

FIG. 6 is an enlarged, partial sectional view taken along line 6-6 of FIG. 5 and including a ramp bar.

FIG. 7 is an enlarged, partial sectional view of a foil having composite material for forming a coating on the plastic frame.

FIG. 8 is a diagrammatic elevation view of an apparatus for forming a decorative coating on a plastic television frame using the foil.

FIG. 9 is a diagrammatic elevation view of the apparatus shown in FIG. 8 illustrating a lowered heated roller for applying heat and pressure to the plastic frame and to the foil.

FIG. 10 is a diagrammatic, partial elevation view of the apparatus shown in FIGS. 8 and 9 after the application of heat and pressure to the plastic frame and to the foil.

FIG. 11 is a diagrammatic isometric view of the plastic frame during the application of heat and pressure to the foil and to the frame.

FIG. 12 is a diagrammatic isometric view of an assembly line for molding plastic television frames, for forming a decorative coating on the frames and for packaging the frames for shipment.

### DETAILED DESCRIPTION OF A PREFERRED EMBODIMENT OF THE INVENTION

While the present invention is open to various modifications and alternative constructions, the preferred embodiment illustrating the best mode contemplated by the inventors of carrying out their invention is shown in the various figures of the drawing and will be described herein in detail, pursuant to Title 35 U.S.C. §112 (first paragraph). It is understood, however, that there is no intention to limit the invention to the particular embodiment, or form or example which is disclosed herein. To the contrary, the intention is to cover all modifications, equivalent structures and methods, and alternative constructions falling within the spirit and scope of the invention as defined in the appended Claims section attached hereto, pursuant to Title 35 U.S.C. §112 (second paragraph).

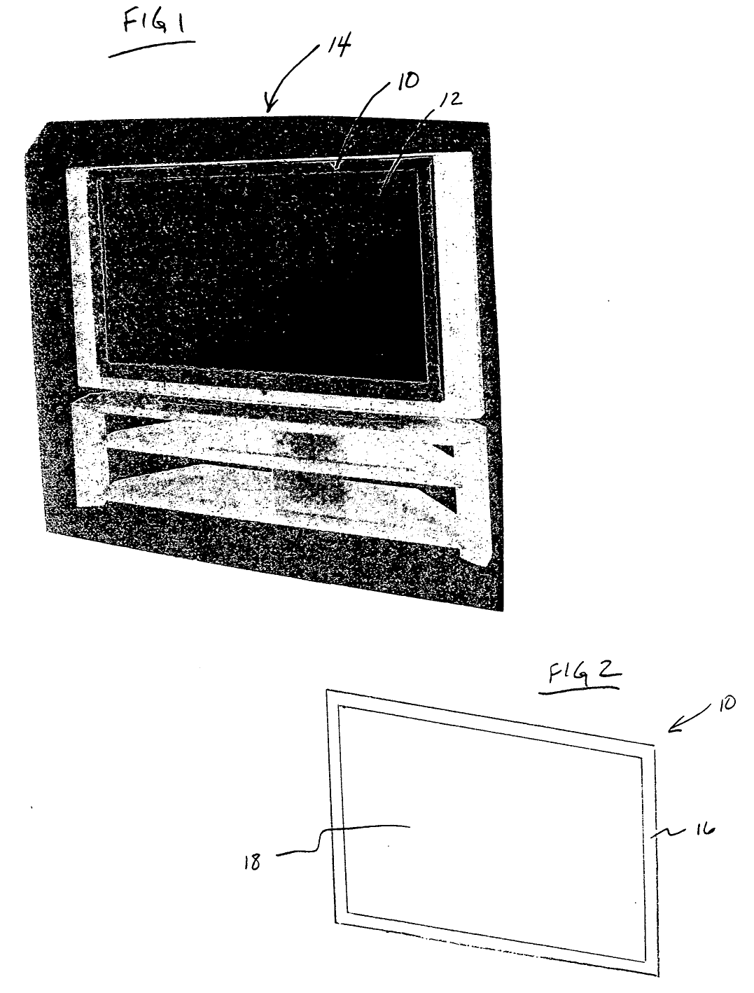

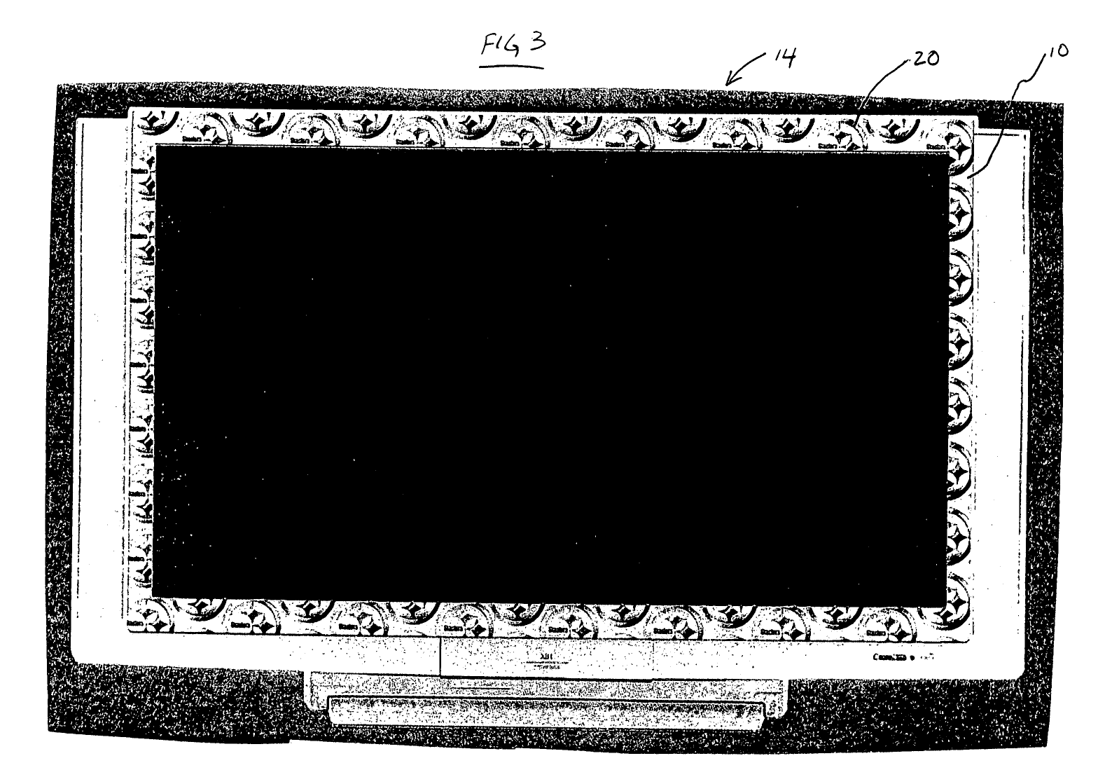

The invention concerns coating a relatively large element where the element has a large discontinuous or interrupted surface. The term “element” is intended to mean broadly any article, item or structure and a large plastic television frame 10, FIG. 1, is an example. The large frame 10 may be used to surround a large flat rectangular screen 12 of a modern television set 14. The term “large and interrupted surface” may be defined by distinguishing such a surface from a large, continuous or uninterrupted surface. An example of the latter is a tabletop. Coating a large, continuous tabletop surface is known. However, an element like the frame 10, with at least a thirty six inches diagonal dimension, and having a peripheral surface 16, FIG. 2, disposed along the border of the frame, has a large interruption in the form of a large rectangular opening 18 in the center of the frame. The techniques used to form a coating on a tabletop will not be suitable for coating a frame. Hence, a table has a large uninterrupted expansive surface but a frame does not have such a surface.

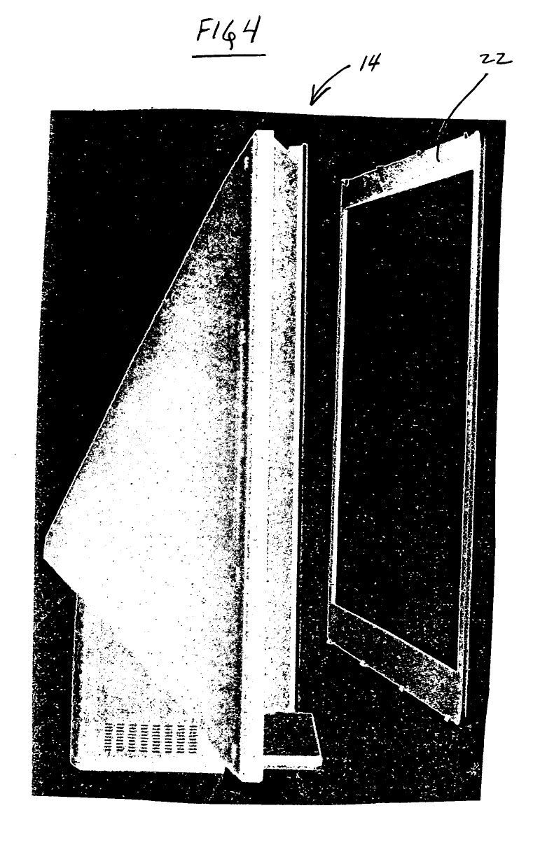

It is commercially desirable to inexpensively coat the “interrupted” peripheral surface of the frame, for example, with a high gloss or mirror finish and/or with the brand of the television manufacturer. Alternatively, a repeated logo 20 of a sports team may be placed on the frame 10 as shown in FIG. 3. Another alternative coating is a particular color so that the frame may be color contrasted with the remainder of the television cabinet or the color of the frame may be coordinated with the color of the room in which the television set is located. Still another commercial advantage of the present invention is the ability to form a decorative coating on a snap-on television frame 22 as shown in FIG. 4. Such an after-market item allows, for example, promotional material to be displayed, sporting events to be announced, general advertising to be issued and home decor versatility to be enhanced, all in a simple but elegant structure that is relatively inexpensive. It is noted that such inexpensive elements are ideally suited for disposable items.

More broadly, the decorative bonding method and apparatus described here allows multiple color variations, graphics, logos and various effects to be conveniently and inexpensively used. The method and apparatus enables quick changes and small lot production, all of which enhances marketability and minimizes cost.

Other advantages of the present invention are that the decorative bonding process disclosed enables a varying degree of gloss to be applied to the frame in a coating with excellent adhesion, abrasion resistance comparable to paint, good chemical resistance and a high production output. The decorative bonding process disclosed herein also provides for color consistency, molecular bonding to substrates, and very good abrasion and scratch resistance.

The inventive method and apparatus also functions without environmentally unfriendly solvents, there is no hazardous waste, there are no airborne pollutants, nor are there any VOC emissions.

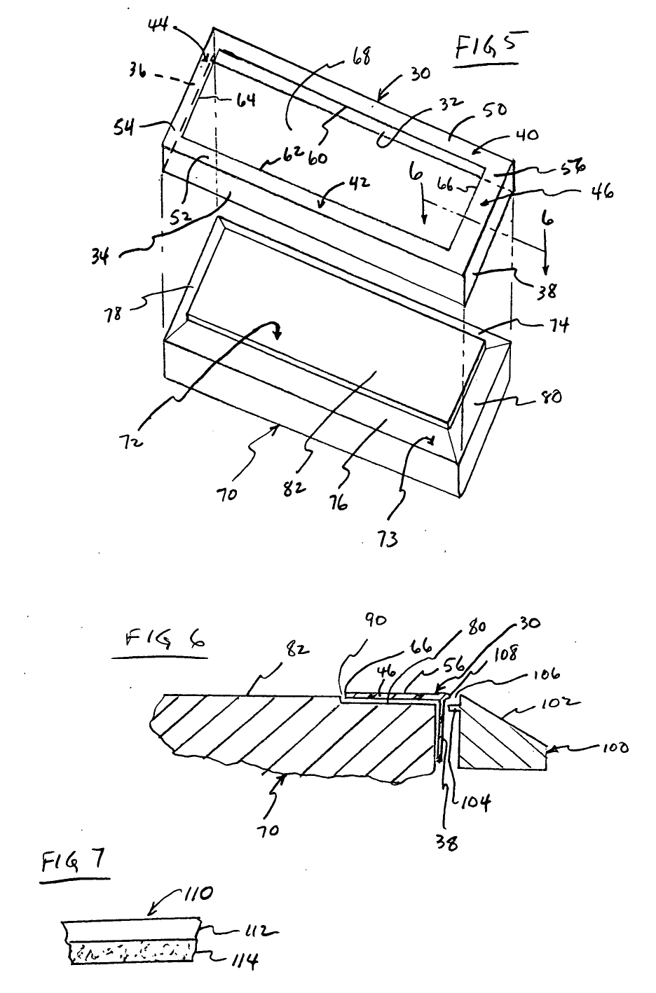

Referring now to FIG. 5, there is illustrated a large television frame 30, the element in the preferred embodiment to be coated or bonded with composite material. The frame 30 is shown in a generally horizontal position as it would appear during the formation of the coating. The frame is formed of injection molded synthetic resin or plastic and is relatively large, having a diagonal dimension of at least thirty-six inches so as to match a television set having a screen of a corresponding dimension. The frame is rectangular in shape and has a generally L-shaped cross-section as shown in FIG. 6. The frame has a pair of long, vertically oriented strips 32, 34, FIG. 5, and a pair of short vertically oriented strips 36, 38, with each pair being integral with the other pair and intersecting the other pair at right angles. The strips of each pair are parallel to one another, the strip 32 being parallel to the strip 34, and the strip 36 being parallel to the strip 38. The frame also includes a pair of long, horizontally oriented strips 40, 42, and a pair of short, horizontally oriented strips 44, 46, one pair of strips intersecting the other pair of strips at right angles. The horizontally oriented strips are integral with each other and with the vertically oriented strips. The strips are generally about 0.100 of an inch in thickness.

The horizontally oriented strips 40, 42, 44, 46 have outer or top surfaces 50, 52, 54, 56, respectively, which form front surfaces when the frame 30 is installed on a television set, as shown in FIG. 1, and represent the surfaces that are to be coated with decorative material. In addition, the frame 30 includes inner edges 60, 62, 64, 66 adjacent to the top surfaces 50, 52, 54, 56, respectively. These edges are visible when the frame is installed and may also be coated or decorated for aesthetic effect as may the portions of the vertically oriented strips 36, 38 immediately adjacent the horizontally oriented strips 44, 46, respectively.

It is apparent that although the surfaces 50, 52, 54, 56 of the horizontally disposed strips are integral and even co-planar, they are discontinuous or interrupted by the center opening 68 of the frame and they do not form a single expanse. To overcome this problem, a specially configured metal fixture 70 is provided. The fixture 70 forms a mounting for the frame. The fixture is configured to have a rectangular shape with a large central portion 72 surrounded by a ledge 73 having four sides 74, 76, 78, 80. The ledge 73 is stepped and is about 0.100 of an inch in elevation below the elevation of a top surface 82 of the central portion 72. The frame is mounted to the fixture such that the horizontally oriented strips 40, 42, 44, 46 rest on the ledge 73 and the top surfaces 50, 52, 54, 56 of the frame 30 and the top surface 82 of the central portion 72 of the fixture 20 are substantially coextensive and may be coplanar. The arrangement of the interrupted frame surfaces 50, 52, 54, 56 and the fixture surface 82 is defined here to be “complementary surfaces” and they form a large expanse analogous to a large tabletop.

The large expanse is generally, but not completely uninterrupted because a small first or inner gap 90, FIG. 6, is created between the fixture top surface 82 and the frame top surfaces 50, 52, 54, 56. The inner gap 90 enables composite material to be heated and pressed so as to adhere to the inner edges 60, 62, 64, 66 of the frame. The gap may be about an eighth of an inch.

A bar 100 FIG. 6 having a slanted surface 102 and a spacer arm 104 is mounted to the fixture 70. The slanted surface 102 of the bar functions as a ramp for engaging a heated roller as will be explained in more detail below. The spacer arm 104 locates the bar a sufficient distance away from the frame so as to provide a second or outer gap 106. The outer gap enables composite material deposited on the frame top surface 56 to also adhere to a lip 108 of the frame.

As noted, the large expanse of the complementary surfaces does not have to be co-planar. The surfaces may be curved or bowed.

The composite material to be deposited on or transferred to the frame is formed on a foil 110, FIG. 7 and broadly includes a carrier layer 112 which may be made of polyester film. Decorative composite material 114 may form another or even several layers disposed on the carrier layer. The decorative composite is specially formulated to result in a coating having good abrasion resistance, good chemical resistance, selective adhesion properties and high gloss characteristics. A mirror finish may also be accomplished. As will be explained in more detail below, the composite material is formulated to adhere to plastic material but not to metal, such as the aluminum fixture 70. This selective adhesion enables the plastic television frame to be coated with composite material when heat and pressure are applied, but the non-plastic metal fixture will not receive the composite material even though heat and pressure are applied.

Suitable decorative foil may be obtained from CFC International, Inc. (“CFC”) of Chicago Heights, Ill., also located on the Internet at www.cfcintl.com. CFC has several product designations currently in use, including M110 Series, M165 Series, G-Series, A-Series, L-Series, R-Series, FC-Series, BL-Series, AC, WR, WB-Series, Sony, EB-AC and EB-AP. Descriptively, M110 Series are bright color metalized products; M165 Series are also bright color metalized products with some abrasion and chemical resistance. G-Series are pigmented products for plastics with slightly improved characteristics compared to metalized products. A-Series and L-Series are pigmented products for plastics. R-Series are also pigmented products for plastics and have modest abrasion and chemical resistance. FC-Series are clear products with much improved abrasion resistance. BL-Series are pigmented products for plastics. AC, WR, WB-Series are printed products for plastics with good abrasion and chemical resistance. Sony designates pigmented products are for plastics with very good abrasion and chemical resistance. EB-AC are printed for MDF and offer great abrasion and chemical resistance. EB-AP also printed for MDF offers the ultimate abrasion and chemical resistance.

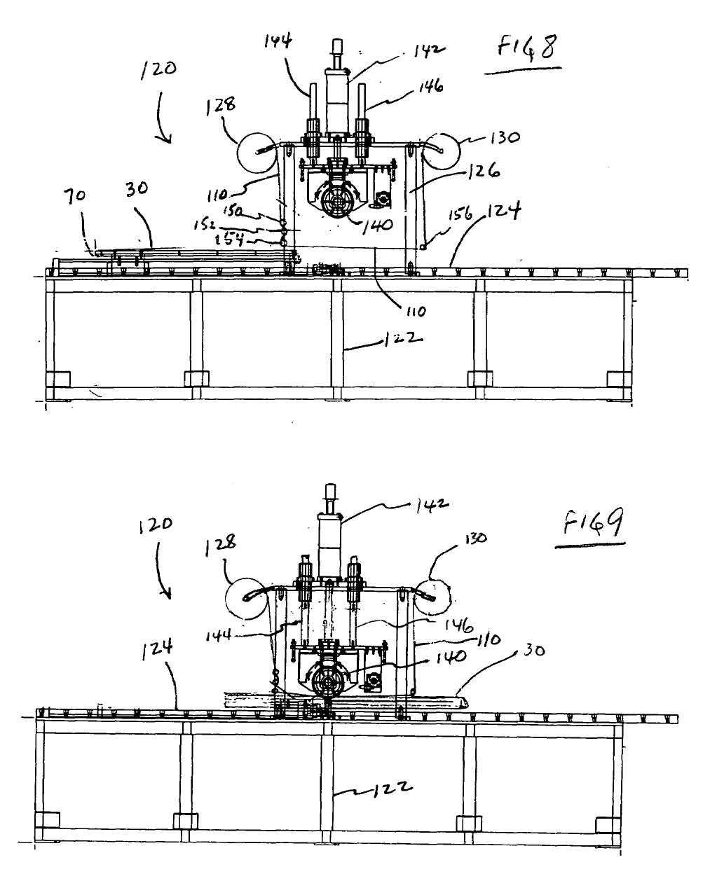

Reference is now made to FIGS. 8-11 to illustrate a coating apparatus 120 that may be used to transfer and bond the composite material and practice the method. The apparatus 120 includes a support base 122 upon which is mounted a conveyor system 124 and a support tower 126. The conveyor system moves left to right in the figures. Supported on the upstream side by the support tower 126 is a foil dispensing roll 128. Supported on the downstream side of the tower is a foil take-up roll 130. Between the dispensing roll 128 and the take-up roll 130 is a heated roller 140, an air cylinder 142, and guide rods 144, 146. The air cylinder 142 and guide rods 144, 146 operate to raise and lower in a precise fashion the heated roller 140 so that heat and pressure may be applied to the foil 110 by having the heated roller press against the foil to squeeze the foil between the roller and the frame and fixture assembly. The heated roller may be free rolling. The foil 110 unwinds from the dispensing roll 128 in response to movement of the frame and fixture assembly and the force of the heated roller which pinches the foil. The take-up roll 130 rewinds the used foil and the application of heat and pressure transfers and bonds composite material from the foil to the frame but not to the metal fixture.

A grouping of three rollers 150, 152, 154 are mounted below the dispensing roll 128 to maintain the foil 110 in a straight and unwrinkled configuration as the foil meets the heated roller 140. Another roller 156 is mounted below the take-up roll 130 to continue maintaining the foil in the straight and unwrinkled configuration.

The support base 122 may be about one hundred and forty-four inches long, about thirty-one inches high and about forty-eight inches wide. The tower 126 and the air cylinder 142 may extend about another sixty inches high. The conveyer system 124 may extend to about one hundred fifty-eight inches long and be about thirty-six inches wide. It is noted that the dimensions disclosed may be extended or shortened as a function of the element, such as the frame 30, to be coated or as a function other manufacturing considerations. The frame may be about fifty-six inches long and about thirty inches wide.

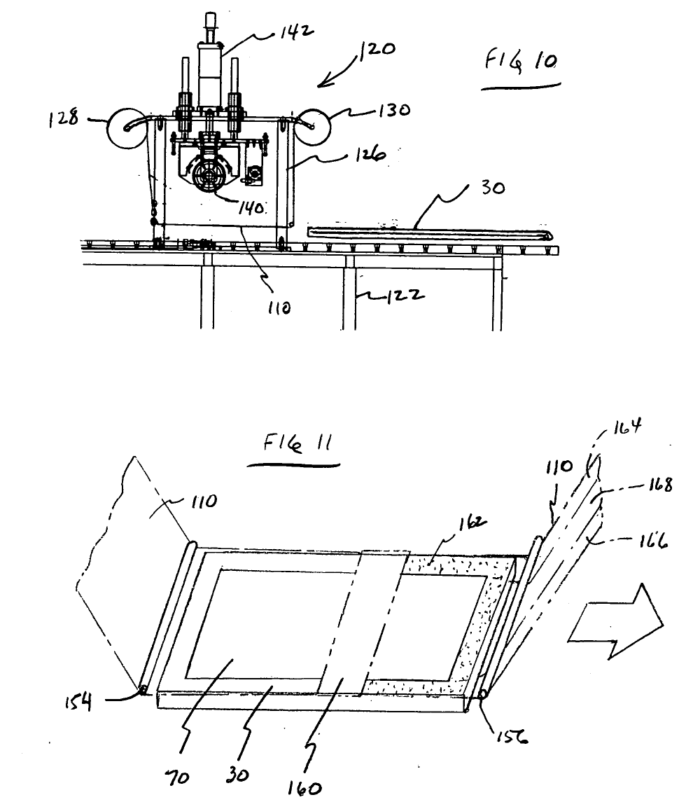

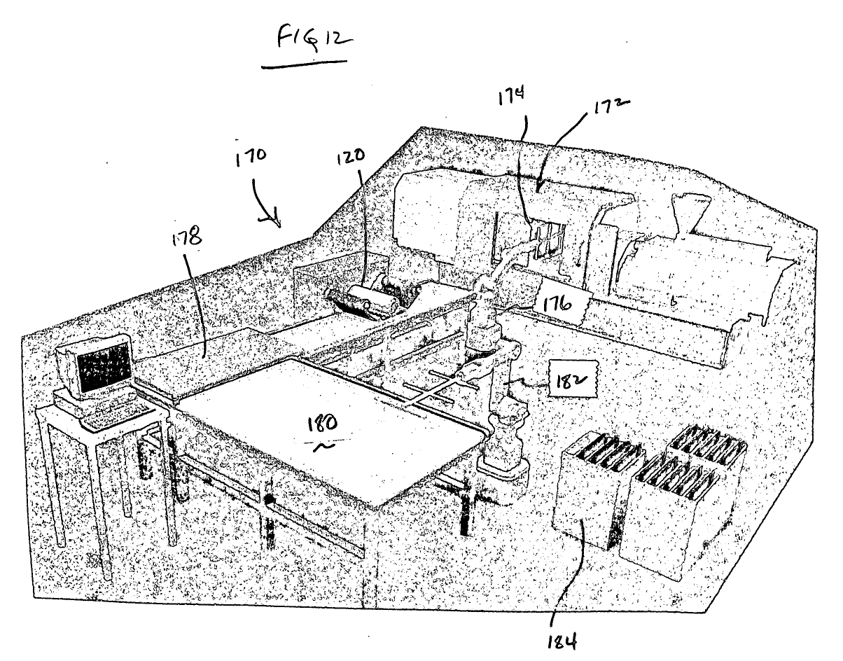

The fixture and frame assembly is placed on the conveyor system 124, FIG. 8, at the left side and the assembly is moved rightwardly along the conveyor system as depicted in FIGS. 9 and 10. When the fixture and frame assembly passes under the tower 126, the foil 110 from the dispensing roll 128 will be positioned over the fixture and frame assembly and the heated roller 140 will apply heat and pressure. The ramp bar 100 assures that the heated roller 140 will gradually and evenly engage the frame and not impact and reflect away or bounce on the foil. The heated roller will provide a footprint, designated 160, FIG. 11, on the foil and on the fixture and frame assembly such that decorative composite material, designated 162 is transferred from the foil and bonded to the frame 30, but no transfer is made to the fixture 70 because the composite material will not adhere to the metal fixture. After transfer, the foil has no composite material at the edges 164, 166, however, composite material still adheres to the foil center portion 168. The fixture and frame assembly continues to move rightwardly while the foil 110 is wound onto the take-up roll 130.

For a fifty-six inch long frame, using M165 Series foil product, it has been found that the temperature of the heated roller should be maintained at about 380 to 400 degrees Fahrenheit, and preferably about 385 degrees Fahrenheit, that about 33 to 43 pounds per square inch of pressure should be applied by the roller, and preferably about 38.4 pounds per square inch, and that the frame passes the heated roller in about thirty-one seconds. The rate of the conveyor system is about nine feet per minute.

It is noted that the temperature of the roller, the pressure applied, and the rate of the conveyor system may vary as a function of the size of the frame, the foil chosen and other factors that may affect the transfer process. It is also noted that an apparatus may be constructed where the fixture and frame assembly may be stationary and the heated roller moves along the foil and the fixture and frame assembly. It is also noted that the fixture and frame assembly may be disposed vertically or obliquely and that the heated roller may move vertically or on a slant.

The process is relatively simple and quick, and also relatively inexpensive. Another advantage of the invention is that the application of the coating allows a less expensive grade of plastic to be used for the frame material. For example, for the frame size disclosed, it is estimated that there may be a thirty percent savings in frame material. Thus the inventive method and apparatus offers enhanced process savings as well as material savings.

A complete processing line 170 may take the configuration shown in FIG. 12. An injection molding machine 172 may be used to form a television frame 174 in a unusual manner. A six-axes robot 176 may transfer the molded frame to the coating apparatus 120. The frame is mounted to a fixture and the fixture and frame assembly moves along the conveyor system in a manner such as that already described in relation to FIGS. 8-10. After the decorative coating has been applied, the decorated frame moves to a quality control station 178 where such characteristics as the quality of gloss, color and surface finish are inspected. After inspection and verification the decorated frame moves to a transfer station 180 where a second six-axes robot 182 transfers the coated frame to a shipping container 184 for addressing and shipment.

The specification disclosed above describes in detail a preferred embodiment of the present invention. Other examples, embodiments, modifications and variations will, under both the literal claim language and the doctrine of equivalents, come within the scope of the invention defined by the appended claims. For example, changing the characteristics of the composite material, the temperature, the pressure or the conveyor system rate, or the size or shape of the frame and fixture are all considered equivalent structures and methods and will also come within the literal language of the claims. Still other alternatives will also be equivalent as will many new technologies. There is no desire or intention here to limit in any way the application of the doctrine of equivalents nor to limit or restrict the scope of the invention.

1. A method for forming a coating to an element having a large and interrupted coating receiving surface, the method comprising the steps of:
engaging the element with a fixture, the fixture having a surface complementing the large and interrupted surface of the element to form with the surface of the element a large generally uninterrupted expanse; and
applying a composite material to the expanse wherein the composite material adheres to the surface of the element and not to the surface of the fixture wherein the surface of the element is coated.

2. The method of claim 1 wherein:
the element is a frame configured to have a rectangular shape with a central opening and the large and interrupted surface bordering the central opening; and
the fixture is configured to have a rectangular shape structured and dimensioned to have the complementing surface disposed within the central opening of the frame.

3. The method of claim 2 including the step of:
mounting the frame to the fixture before applying the composite material.

4. The method of claim 3 wherein:
the frame is configured to have an L-shaped cross section; and
the fixture includes a stepped periphery.

5. The method of claim 2 wherein:
a gap is formed between the complementing surface of the fixture and the large and interrupted surface of the frame.

6. The method of claim 1 wherein:
the coating has abrasion resistance, chemical resistance and selective adhesion properties.

7. The method of claim 6 wherein:
the coating has a high gloss.

8. The method of claim 6 wherein:
the element is formed of synthetic resin;
the fixture is formed of metal; and
the composite material adheres to synthetic resin and not to metal.

9. The method of claim 1 wherein:
the composite material is carried on a film layer.

10. The method of claim 9 wherein:
the composite material and the film layer are formed on a roll.

11. The method of claim 1 wherein:
the applying step includes the application of heat and pressure.

12. The method of claim 1 wherein:
the element is a frame configured to have a rectangular shape with a central opening and the large and interrupted surface is bordering the central opening;
the fixture is configured to have a rectangular shape structured and dimensioned to have the complementing surface disposed within the central opening of the frame;
the coating on the element has abrasion resistance, chemical resistance and selective adhesion properties; and
the composite material is carried on a film layer.

13. The method of claim 12 wherein:
the composite material and the film layer are formed on a roll; and
the applying step includes the application of heat and pressure.

14. The method of claim 13 wherein:
applying the composite material to the frame by a bearing a heated roller against the film layer.

15. A method for forming a coated frame having a large and interrupted surface, the method comprising the steps of:
forming a frame of synthetic resin;
mounting the formed frame on a fixture, the fixture having a surface complementing the large and interrupted surface of the frame to form with the surface of the element a large generally uninterrupted expanse; and
applying a composite material to the expanse wherein the composite material adheres to the surface of the element and not to the surface of the fixture.

16. The method of claim 15 including the steps of:
placing the frame and the fixture on a conveyor system;
moving the fixture and frame assembly along the conveyor system;
mounting a roll of foil adjacent the conveyor system, the foil carrying the composite material; and wherein
the applying step includes using a heated roller to press the foil against the fixture and frame assembly.

17. The method of claim 16 including the steps of:
removing the coated frame from the fixture; and
packaging the coated frame.

18. A foil for the application of a coating to an element having a large and interrupted coating receiving surface, the foil comprising:
a film carrier; and
a layer of composite material deposited on the film carrier which after the application of heat and pressure is transferred to a large and interrupted surface and results in a coating having abrasion resistance, chemical resistance and selective adhesion properties.

19. The foil of claim 18 wherein:
the film carrier and composite material is formed on a roll.

20. The foil of claim 19 wherein:
the layer of composite material is responsive to heat and pressure to adhere to synthetic resin and not to metal wherein only a portion of the composite material is transferred after the application of heat and pressure.

21. An apparatus for forming a coating to a large, interrupted surface of an element comprising:
a fixture for mounting the element having the large, interrupted surface to be coated, the fixture being structured and dimensioned to complement the large, interrupted surface;
a base for supporting the fixture;
a heated roller movably supported by the base for applying heat and pressure; and
a sheet of foil positioned adjacent the fixture mounted element, the foil including a composite material to be transferred by heat and pressure from the foil to the element and not to the fixture.

22. The apparatus of claim 21 wherein:
the fixture includes a raised surface.

23. The apparatus of claim 22 wherein:
the raised surface of the fixture is generally coplanar with the surface of the element to be coated; and the fixture including a ramp.

24. The apparatus of claim 22 wherein:
the fixture includes a ledge for engaging and supporting the element.

25. The apparatus of claim 21 wherein:
the composite material on the sheet of foil results in a coating having abrasion resistance, chemical resistance and selective adhesion.

26. The apparatus of claim 25 wherein:
the sheet of foil is formed on a dispensing roll.

27. The apparatus of claim 26 including:
a take-up roll for receiving the sheet of foil after the coating is formed.

28. The apparatus of claim 27 wherein:
the fixture includes a raised surface.

29. The apparatus of claim 28 wherein:
the raised surface of the fixture is generally coplanar with the surface of the element to be coated; and including
a ramp located adjacent the fixture.

30. The apparatus of claim 28 including:
a conveyor system supported by the base; and wherein
the fixture is supported by the conveyor system to move passed the heated roller;
the dispensing roller disposed upstream of the heated roller; and
the take-up roller is disposed downstream of the heated roller.

31. A manufacturing system comprising:
a molding apparatus for forming an element having a large, interrupted surface to be coated;
an apparatus for forming a coating to the large, interrupted surface, the coating apparatus including a fixture for mounting the element, a conveyor system for moving the fixture mounted element, a dispensing roll of foil, a take-up roll for the foil, and a heated roller, the fixture being structured and dimensioned to complement the large, interrupted surface of the element and the roll of foil having a composite material to be transferred upon the application of heat and pressure from the roll of foil to the large, interrupted surface of the element; and
a packaging station for receiving coated elements from the coating apparatus.

32. The manufacturing system of claim 31 wherein:
the coating applied to the large, interrupted surface of the element has abrasion resistance, chemical resistance and selective adhesion; and
no composite material is transferred to the fixture after the application heat and pressure.
